(19) United States
(12) Patent Application Publication
(10) Pub. No.: US 2015/0186617 A1
(43) Pub. Date: Jul. 2, 2015

(54) SYSTEM AND METHOD FOR PROBABILISTIC EVALUATION OF CONTEXTUALIZED REPORTS AND PERSONALIZED RECOMMENDATION IN TRAVEL HEALTH PERSONAL ASSISTANTS

(71) Applicant: INTERNATIONAL BUSINESS MACHINES CORPORATION, Armonk, NY (US)

(72) Inventors: Carlos H. Cardonha, Sao Paulo (BR); Christian Guttmann, Melbourne (AU); Fernando L. Koch, Sao Paulo (BR)

(73) Assignee: INTERNATIONAL BUSINESS MACHINES CORPORATION, Armonk, NY (US)

(21) Appl. No.: 14/142,125

(22) Filed: Dec. 27, 2013

(51) Int. Cl. G06F 19/00; G06N 7/02

(52) U.S. Cl. CPC G06F 19/3487; G06N 7/02

(57) ABSTRACT

A method for providing health-related recommendations based on previous end-user travel reports including: receiving data indicative of a current location or destination of a user; calculating correlation probabilities between a plurality physical conditions reported by a plurality of users in the current location or destination versus parameters of health context information of the current location or destination versus parameters of the user's profile; and providing the user with a personalized health-related recommendation based on the calculated correlation probabilities.

### BACKGROUND

1. Technical Field

The present invention relates to travel health monitoring and advice, and more particularly, to travel health monitoring and advice via a mobile platform.

2. Discussion of the Related Art

More than 900 million international journeys are undertaken every year. Global travel on this scale exposes many people to a range of health risks. Many of these risks can be minimized by precautions taken before, during and after travel.

### BRIEF SUMMARY

In an exemplary embodiment of the present invention, a method for providing health-related recommendations based on previous end-user travel reports comprises: receiving data indicative of a current location or destination of a user; calculating correlation probabilities between a plurality physical conditions reported by a plurality of users in the current location or destination versus parameters of health context information of the current location or destination versus parameters of the user's profile; and providing the user with a personalized health-related recommendation based on the calculated correlation probabilities.

The calculation of the correlation probabilities includes calculating a first impact factor of the health context information and reported physical conditions.

The calculation of the correlation probabilities includes calculating a second impact factor of the user's profile and reported physical conditions.

The method further comprises calculating a third impact factor of the health context information, user's profile and reported physical conditions using the first and second impact factors.

The method further comprises calculating a fourth impact factor of a recommendation, the user's profile and reported physical conditions using the second impact factor.

The method further comprises calculating a most relevant recommendation for the user given the third and fourth impact factors and recommendation rules and providing the most relevant recommendation, as the health-related recommendation, to the user.

The method further comprises evaluating effectiveness of the recommendation provided to the user.

The method further comprises adjusting the recommendation rules based on the effectiveness evaluation.

The health-related recommendation includes a hot spot identifying a health risk situation.

The method further comprises receiving information from users via a mobile device operating a citizen sensing application.

The health-related recommendation is provided to the user via a citizen sensing application operating on a mobile device.

In an exemplary embodiment of the present invention, a computer program product for providing health-related recommendations based on previous end-user travel reports comprises: a computer readable storage medium having computer readable program code embodied therewith, the computer readable program code comprising: computer readable program code configured to receive data indicative of a current location or destination of a user; computer readable program code configured to calculate correlation probabilities between a plurality physical conditions reported by a plurality of users in the current location or destination versus parameters of health context information of the current location or destination versus parameters of the user's profile; and computer readable program code configured to provide the user with a personalized health-related recommendation based on the calculated correlation probabilities.

The calculation of the correlation probabilities includes calculating a first impact factor of the health context information and reported physical conditions.

The calculation of the correlation probabilities includes calculating a second impact factor of the user's profile and reported physical conditions.

The computer program product further comprises computer readable program code configured to calculate a third impact factor of the health contact information, user's profile and reported physical conditions using the first and second impact factors.

The computer program product further comprises computer readable program code configured to calculate a fourth impact factor of a recommendation, the user's profile and reported physical conditions using the second impact factor.

The computer program product further comprises computer readable program code configured to calculate a most relevant recommendation for the user given the third and fourth impact factors and recommendation rules and providing the most relevant recommendation, as the health-related recommendation, to the user.

The computer program product further comprises computer readable program code configured to evaluate effectiveness of the recommendation provided to the user.

The health-related recommendation includes a hot spot identifying a health risk situation.

In an exemplary embodiment of the present invention, a system for providing health-related recommendations based on previous end-user travel reports comprises: a memory device for storing a program; and a processor in communication with the memory device, the processor operative with the program to: receive data indicative of a current location or destination of a user; calculate correlation probabilities between a plurality physical conditions reported by a plurality of users in the current location or destination versus parameters of health context information of the current location or destination versus parameters of the user's profile; and provide the user with a personalized health-related recommendation based on the calculated correlation probabilities.

### BRIEF DESCRIPTION OF THE SEVERAL VIEWS OF THE DRAWINGS

FIG. 1 illustrates a method of collecting and analyzing parameters according to an exemplary embodiment of the present invention;

FIGS. 2A and 2B illustrate a system architecture according to an exemplary embodiment of the present invention;

FIG. 3 illustrates a causality model according to an exemplary embodiment of the present invention; and

FIG. 4 illustrates an apparatus for implementing an exemplary embodiment of the present invention.

### DETAILED DESCRIPTION

The present invention provides a system and method for calculating the impact of contextual and profile parameters in end-user travel reports, through a set of probabilistic mathematical models to classify, correlate and rank these parameters. Moreover, the present invention provides methods to generate, select and rank recommendations based on observed events, calculated parameters, and recommendation rules and also methods to self-adjust the recommendation rules based on mathematical models to calculate the performance of recommendations in relation to reports, context and profile.

The present invention classifies and understands the causal relations between situation parameters, end-user profiles and travel health reports. The present invention provides a method for probabilistic calculation of causal relations that lead to deep understanding on how contextual and profile parameters influence travel health reports and conversely how attributes of travel health reports are related to contextual and profile parameters. The present invention implements (i) a recommendation system for travel health information based on a probabilistic distribution of causal events and (ii) a holistic analysis of travel health conditions and how they relate to local and regional context based on a correlation analysis of incoming travel reports and extrapolation of cause-effect relations.

A system implementing an exemplary embodiment of the present invention will be able to (i) better classify, prioritize, and filter travel health reports entered by end-users through crowd source applications (e.g., participatory sensing), (ii) provide a recommendation engine for contextualized and personalized travel health reports, and (iii) anticipate hot areas and possible recommendations based on the extrapolation of cause-effect relations inferred from other reports in related context and profile situations.

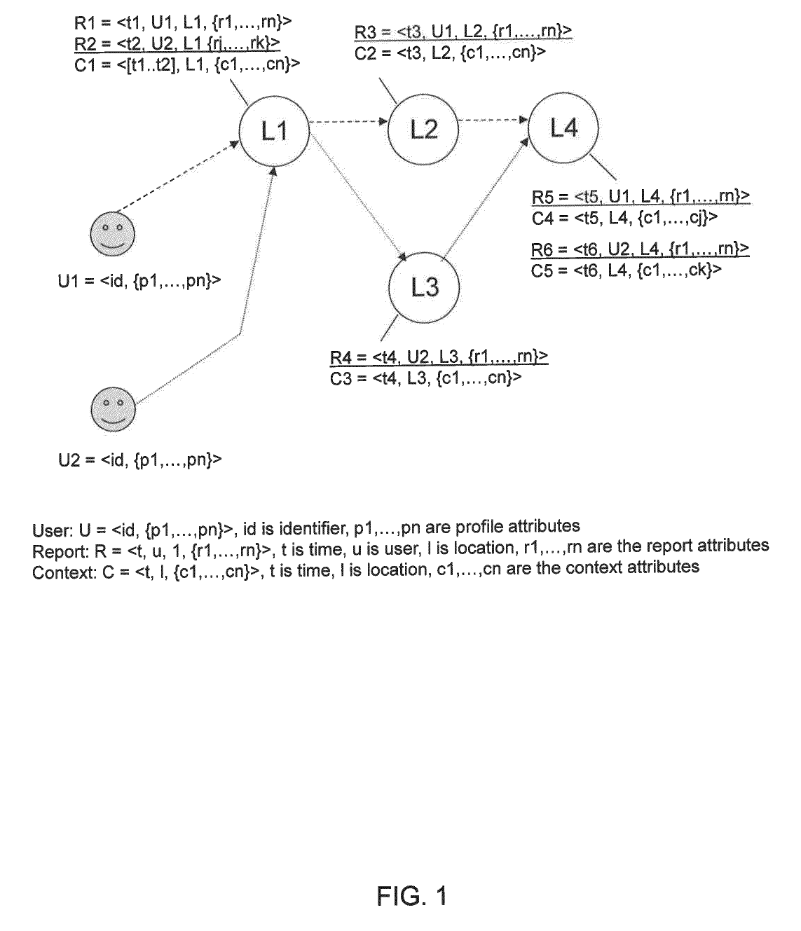

FIG. 1 illustrates a method of collecting and analyzing parameters according to an exemplary embodiment of the present invention.

In brief, in the method illustrated in FIG. 1, there exists a central operation center (not shown) for travel health with data repositories containing contextual information per location/time, user profiles and others. End-users (e.g., U1 and U2) interact through a mobile app to report health conditions while traveling; these reports contain, for example, answers to questions about their health conditions and collections of sensor data, such as vital signs, and others. End-users travel to different areas (e.g., L1-L4), reporting their personal observations, in conditions that are unique to that area or shared by different areas.

Mores specifically, as shown in FIG. 1, a first user (e.g., U1) is mathematically represented as U1=<id, (p1, . . . , pn)>. Here, id is an identifier of the first user and p1, . . . , pn are profile attributes of the first user. Profile attributes of the first user may include, for example, the user's age, history of diseases, health behavior, etc. A second user (e.g., U2) is mathematically represented as U2=<id, {p1, . . . , pn}>, with id being an identifier of the second user and p1, . . . , pn being profile attributes of the second user.

L1 may represent a first location. The first location may be a travel destination of the first and second users. While at the first location, the first and second users may report their health conditions. The first user's report may be mathematically represented as R1=<t1, U1, L1, {r1, . . . , rn}>. Here, t1 is time, U1 is user, L1 is location, r1, . . . , rn are the report attributes. The report attributes may include, for example, answers to questions about the first user's health conditions and collections of sensor data, such as vital signs, and others. The second user's report may be mathematically represented as R2=<t1, U2, L1, {rj, . . . , rk}>. Here, t1 is time, U2 is user, L1 is location, rj, . . . , rk are the report attributes.

C1 may represent context information of the first location L1. The contextual information may include parameters of the first location such as temperature, quality of water, reports of disease outbreaks and other reports. The context may be represented mathematically as C1=[t1 . . . tm], L1, {c1, . . . , cn}>. Here, ti is time for 1<=i<=m, L1 is location, c1, . . . , cn are the context attributes.

The rest of the locations L2, L3 and L4 in FIG. 1 include travel reports R3-R6 from the user's U1 and U2 as well as context information C2-C5 of the locations L2, L3 and L4.

Using the aforementioned information, the method may correlate the conditions being reported Ri in a visited region (e.g., fever, diarrhea, fast heartbeat, others) with parameters of contextual information Ci in the visited region (e.g., temperature, quality of water, reports of disease outbreaks, other reports) and parameters of the user's profiles Pi (e.g., age, history of diseases, health behavior, etc.). The method may then calculate correlation probabilities between Ri versus Ci versus Pi. Details of this calculation will be discussed later in reference to an inventive mathematical model.

The method can derive recommendation rules using the calculated correlation probabilities of Ri versus Ci versus Pi, describing for example that an end-user with profile Pi in a condition Ci will most likely report Ri; thus, this person should apply a recommended action Xi to avoid the condition.

The method can implement extrapolations upon the relationship of Ri versus Ci versus Pi in defined areas, and correlate similar conditions from different areas, to anticipate conditions and events, and report existing and future hot spots and disease areas.

The method can also implement analysis of individual reports, related to conditions and profile, extrapolation situations and applies the recommendation rules to identify possible risk factors to individuals during their trip and upon return. This information can be used by health authorities for recommendation and preventative treatment.

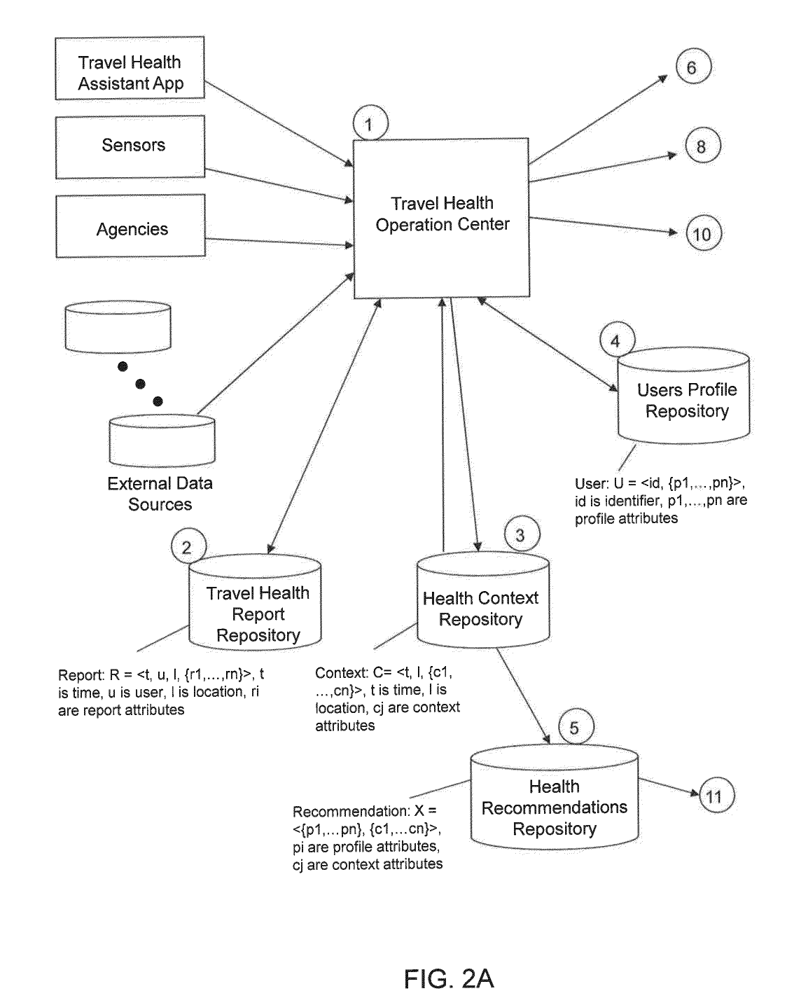

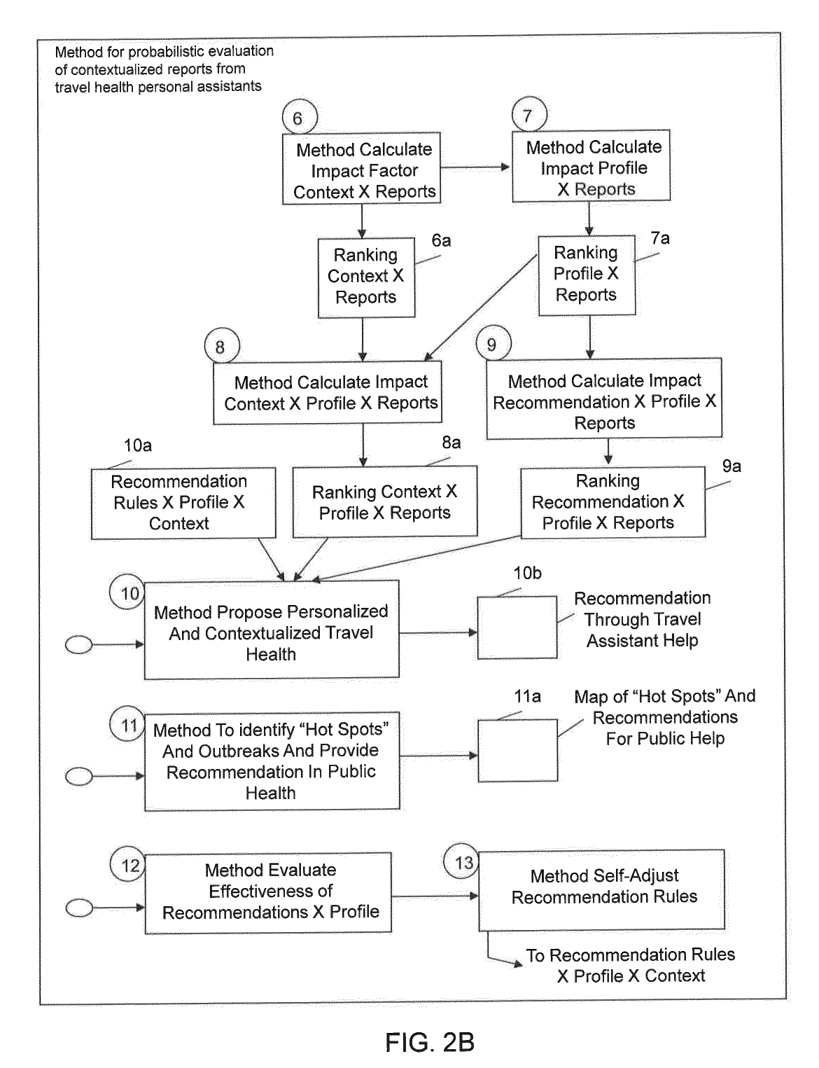

The aforementioned aspects of the inventive method will now be elucidated more fully with reference to FIGS. 2A and 2B in which a system architecture according to an exemplary embodiment of the present invention is shown.

As shown in FIG. 2A, a travel health operation center is provided. This operation center may be implemented as a server. The travel health operation center receives travel health data from a variety of sources. The sources may include a travel health assistant app operable on a traveler's mobile device such as a smartphone, sensors such as wearable daily activity trackers, water quality sensors, government travel agencies and other external data sources that may provide information associated with the health of persons in a general locale.

In further communication with the travel health operation center are a travel health repository, health context repository, users profile repository and health recommendations repository. The travel health operation center may perform an operation 1 in which raw data from the travel app, sensors, agencies and other data sources is stored and made accessible to the repositories.

The travel health repository may store reports provided from a plurality of users 2, the health context repository may store context information associated with a plurality of locations 3, the users profile repository may store a plurality of user profiles 4 and the health recommendations repository may store recommendations for users with particular profiles in particular contexts 5. As an example, a health recommendation may be represented mathematically as X=<{x1, . . . , xn}, {p1, . . . , pn}, {c1, . . . , cn}>, pi are profile attributes, cj are context attributes, and xi are the recommendations.

Turning now to FIG. 2B, a method for probabilistic evaluation of contextualized reports from travel health personal assistants according to an exemplary embodiment of the present invention, which is implemented by the travel health operation center, will now be described.

In particular, the method takes input from repositories 2 and 3 and may calculate the impact of context and reports 6, suggesting the severity as a combination of reported incidents and context information. For example, if many travelers report diarrhea which coincides with information about water quality at a certain location, then this particular location is associated with an impact factor (maybe 9 out of 10). Likewise, if few bad reports or bad context information is present for a certain location, then the severity factor is low (maybe 1 out of 10). This is then ranked by impact factor 6a.

Like the operation just described, the method takes input from repositories 2 and 4 and may calculate the impact of profile and reports 7. An example here would be that the combination of an elderly person (user profile) and reports of diarrhea in a certain location has a higher impact factor (maybe 6 out of 10) than the same reports with a young person (maybe 2 out of 10). Again, the outcome of this module is ranked by severity 7a.

The method takes input from repositories 2-4, calculates impact of context, profile and reports 8 and combines it into an overall severity ranking 8a.

To correctly compute the impact of locations and user profiles, a causality model described by an inventive mathematical formulation (discussed later) is employed. The causality model is necessary because it allows the real impact of different contexts to be identified, as it takes into account the influence of different factors simultaneously. In the case of aspects accounted for in method step 6 (impact of locations), for example, it is computed how often disease reports of a certain kind are submitted from users in the given context, where the frequency may be the number of reports submitted per hour, day, etc. Based on this information, impact factors are assigned to locations using the average occurrences over time, possibly using techniques based on exponential smoothing to give a higher weight to recent reports.

The method takes input from repositories 2, 4 and 5, to determine which recommendations and guidelines are to be applied for a particular user in a particular context 9, and given certain results, it ranks all combinations 9a. For example, an elderly person entering a location which is associated with many bad health care reports on a hot day is recommended not to enter this area (because given the outcomes of the mathematical model, the probability is high for a hazard). The recommendations are different for a young person in colder weather.

In 10, the information of 8 and 9 are taken together (the highest ranking ones) to make a final calculation of which are the most relevant recommendation for a given situation. In other words, the method of 10 proposes personalized and contextualized travel health (also using recommendation rules 10a) and provides the recommendation through a travel help assistant app to a traveler 10b. Although more parameters are being considered, the same technique is used to calculate the impact factor of locations and user profiles to evaluate the impact factor of recommendations.

In 11, the overall impact is assessed and a public view is provided from the overall reports. For example, hot spots may be identified in 11 and communicated to travelers along with recommendations in 11a. Hot spots may be locations with the highest overall impact factors given the different calculations 6-10. Such information may be useful for a health authority and public use.

In 12, the method computes if a recommendation has been followed (e.g., it measures whether a traveler has entered a location despite being warned), and if it therefore had an effect on their behavior. If the measures are not adequately followed, in 13 the method provides a feedback loop to the recommendation procedure 10a, possibly changing which recommendations are more adequate than others. Here, user feedback can be accounted for by incorporating a new artificial parameter, which basically describes the percentage of positive feedback.

An illustrative scenario involving the system and method disclosed herein is now provided.

Let us consider that a health authority provides a travel app to identify and mitigate infectious disease outbreaks. Using this app, end-users can provide information about their health status while they travel, for example, by providing information of their body temperature and general well-being in given contexts.

Let us assume that there is a traveler A in location L1 whose health is compromised by eating infected food in a café close to location L1. Traveler A is more adventurous trying more risky activities and foods. Moreover, the region that traveler A visits is not well explored and mapped out, for example restaurants are not clearly marked. Consequently, little is known about the effect of hazards about the area, both due to a lack of context knowledge and dynamics in the environment.

Let us also assume that there is a traveler B that travels a similar route to traveler A. Moreover, traveler B has similar profile characteristics to traveler A, in other words, they are of the same age and are both suffering from asthma. Both are travelling the route as they planned, and both experience similar events in the locations they visited.

Traveler A and traveler B have their visits and enter reports indicating their health status regularly, for example, after eating certain foods and visiting certain places. A typical approach for this situation is to collate reports from these two travelers and classify the most similar reports based on counting and clustering of reports (as per time, location, event, etc.) and filtering (e.g., identifying and filtering out deviant behavior such as multiple reports from the same user to same location or restaurant in a short period of time).

However, this method of ranking is prone to error and bias. In the scenario illustrated above, a simple counting of reports with bad experiences could lead to the conclusion that traveler A is doing more hazardous activities than traveler B, as they are less likely to experience positive reports due to the negative conditions of the environment.

A classification system implementing an exemplary embodiment of the present invention would take into consideration the characteristics of the local context to provide a higher rank to reports coming from traveler A. This way, the classification of the most remarkable hot spots (encompassing different locations) becomes more balanced towards regions striving to provide good service despite of the adventurous spirit of traveler A.

The inventive mathematical model will now be discussed.

An implementation of the method according to an exemplary embodiment of the present invention can be obtained if a suitable causality model is identified and employed for the particular scenario being considered. To construct such a model, we initially need a table that gives the probability P(Ri,Ci,Pi) with which condition Ri is reported given contextual information item Ci and user profile item Pi. Ri are binary random variables that assume 1 if condition Ri is reported and 0 else. Contextual information Ci (temperature, quality of water, etc.) and profile information Pi (age, health, behavior, etc.) can be discretized, so such table can be obtained from a training set T of reports by direct computation of normalized frequencies. More precisely, given a report r, if we say that whenever report r describes the occurrence of condition Ri under Ci and Pi−P(Ri,Ci,Pi) can be obtained as follows:

Depending on |R|, |C|, and |P|, the computation of P(Ri|Ci,Pi) becomes a computationally intractable problem, as the computation of such marginal probabilities can involve a large number of elements.

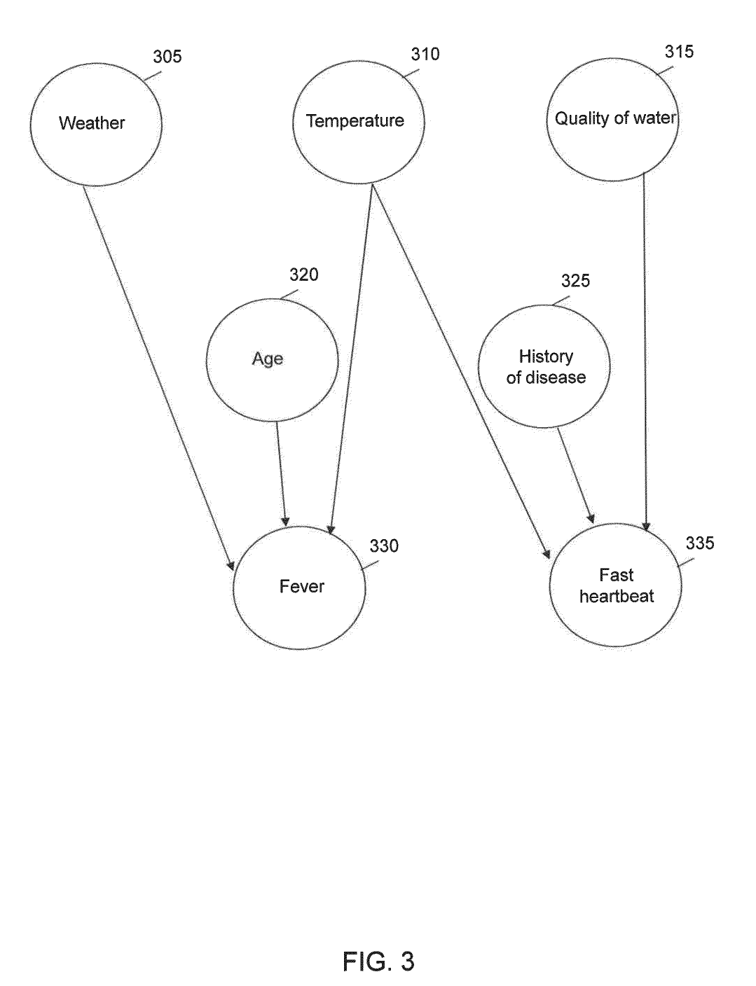

To avoid this and minimize computation efforts, we can use a causal model that can be obtained, e.g., via structural equation modeling (done with the support of multiple regression, for example). Such techniques investigate if there are correlations between two random variables taking into account which variables influence the others. An example causality model is shown in FIG. 3.

Such a causality model shows that fever 330 depends on weather 305 and temperature 310 (e.g., contextual information) and on age 320 (e.g., profile information) and that it is not related to quality of water 315 (e.g., contextual information) and history of disease 325 (e.g., profile information). In other words, probability P(Fever|Age,Disease,Weather,Temperatue,Water) is equal to P(Fever|Age,Weather,Temperature), which is easier to compute.

Based on these models, one can compute the probability of occurrences of condition Ri under a set of contextual information Ci and a set of profile information Pi. Therefore, if a certain user with profile Pi is reaching a context Ci, the probability of having a report Ri being submitted by this user can be directly computed from the causality model (which can be readjusted and upgraded as new conditions appear and/or new evidence shows that certain correlations are not being confirmed by the data anymore).

Correlation between different areas can be assessed with traditional techniques, and thus, causality models are not used. Therefore, predicting that certain conditions will be reported in an area simply consists of monitoring the evolution of contextual information and profile information from users and comparing them with information that happened in the past in correlated areas.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

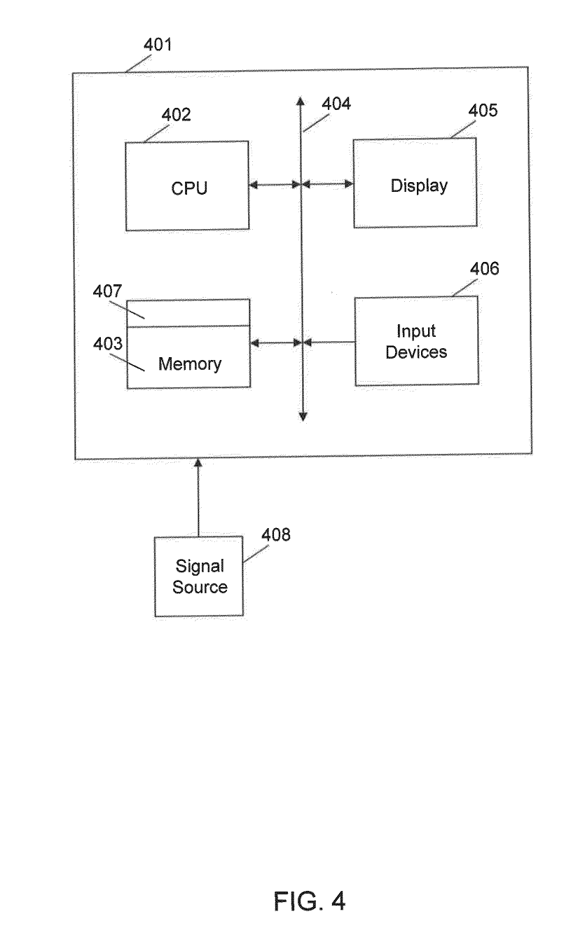

Referring now to FIG. 4, according to an exemplary embodiment of the present invention, a computer system 401 can comprise, inter alia, a CPU 402, a memory 403 and an input/output (I/O) interface 404. The computer system 401 is generally coupled through the I/O interface 404 to a display 405 and various input devices 406 such as a mouse and keyboard. The support circuits can include circuits such as cache, power supplies, clock circuits, and a communications bus. The memory 403 can include RAM, ROM, disk drive, tape drive, etc., or a combination thereof. Exemplary embodiments of present invention may be implemented as a routine 407 stored in memory 403 (e.g., a non-transitory computer-readable storage medium) and executed by the CPU 402 to process the signal from the signal source 408. As such, the computer system 401 is a general-purpose computer system that becomes a specific purpose computer system when executing the routine 407 of the present invention.

The computer platform 401 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical functions(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing health-related recommendations based on previous end-user travel reports, comprising:
receiving data indicative of a current location or destination of a user;
calculating correlation probabilities between a plurality physical conditions reported by a plurality of users in the current location or destination versus parameters of health context information of the current location or destination versus parameters of the user's profile; and
providing the user with a personalized health-related recommendation based on the calculated correlation probabilities.

2. The method of claim 1, wherein the calculation of the correlation probabilities includes calculating a first impact factor of the health context information and reported physical conditions.

3. The method of claim 2, wherein the calculation of the correlation probabilities includes calculating a second impact factor of the user's profile and reported physical conditions.

4. The method of claim 3, further comprising calculating a third impact factor of the health context information, user's profile and reported physical conditions using the first and second impact factors.

5. The method of claim 4, further comprising calculating a fourth impact factor of a recommendation, the user's profile and reported physical conditions using the second impact factor.

6. The method of claim 5, further comprising calculating a most relevant recommendation for the user given the third and fourth impact factors and recommendation rules and providing the most relevant recommendation, as the health-related recommendation, to the user.

7. The method of claim 6, further comprising evaluating effectiveness of the recommendation provided to the user.

8. The method of claim 7, further comprising adjusting the recommendation rules based on the effectiveness evaluation.

9. The method of claim 1, wherein the health-related recommendation includes a hot spot identifying a health risk situation.

10. The method of claim 1, further comprising receiving information from users via a mobile device operating a citizen sensing application.

11. The method of claim 1, wherein the health-related recommendation is provided to the user via a citizen sensing application operating on a mobile device.

12. A computer program product for providing health-related recommendations based on previous end-user travel reports, comprising:
a computer readable storage medium having computer readable program code embodied therewith, the computer readable program code comprising:
computer readable program code configured to receive data indicative of a current location or destination of a user;
computer readable program code configured to calculate correlation probabilities between a plurality physical conditions reported by a plurality of users in the current location or destination versus parameters of health context information of the current location or destination versus parameters of the user's profile; and
computer readable program code configured to provide the user with a personalized health-related recommendation based on the calculated correlation probabilities.

13. The computer program product of claim 12, wherein the calculation of the correlation probabilities includes calculating a first impact factor of the health context information and reported physical conditions.

14. The computer program product of claim 13, wherein the calculation of the correlation probabilities includes calculating a second impact factor of the user's profile and reported physical conditions.

15. The computer program product of claim 14, further comprising computer readable program code configured to calculate a third impact factor of the health contact information, user's profile and reported physical conditions using the first and second impact factors.

16. The computer program product of claim 15, further comprising computer readable program code configured to calculate a fourth impact factor of a recommendation, the user's profile and reported physical conditions using the second impact factor.

17. The computer program product of claim 16, further comprising computer readable program code configured to calculate a most relevant recommendation for the user given the third and fourth impact factors and recommendation rules and providing the most relevant recommendation, as the health-related recommendation, to the user.

18. The computer program product of claim 17, further comprising computer readable program code configured to evaluate effectiveness of the recommendation provided to the user.

19. The computer program product of claim 12, wherein the health-related recommendation includes a hot spot identifying a health risk situation.

20. A system for providing health-related recommendations based on previous end-user travel reports, comprising:
a memory device for storing a program; and
a processor in communication with the memory device, the processor operative with the program to:
receive data indicative of a current location or destination of a user;
calculate correlation probabilities between a plurality physical conditions reported by a plurality of users in the current location or destination versus parameters of health context information of the current location or destination versus parameters of the user's profile; and
provide the user with a personalized health-related recommendation based on the calculated correlation probabilities.
